(19) United States
(12) Patent Application Publication
(10) Pub. No.: US 2015/0353056 A1
(43) Pub. Date: Dec. 10, 2015

(54) WIPER BLADE AND ADAPTOR THEREOF

(71) Applicant: Unipoint Electric Mfg. Co. Ltd., Ping-Chen (TW)

(72) Inventors: Andreas Benner, Ping-Chen (TW); Sam Lai, Ping-Chen (TW); Irving Chiu, Ping-Chen (TW); Hsuhui Huang, Ping-Chen (TW); Chienhung Lai, Ping-Chen (TW)

(21) Appl. No.: 14/730,355

(22) Filed: Jun. 4, 2015

(30) Foreign Application Priority Data
Jun. 6, 2014 (CN) 201410248244.1

(51) Int. Cl. B60S 1/40

(52) U.S. Cl. CPC B60S 1/40; B60S 2001/4093

(57) ABSTRACT

A wiper blade and an adapter thereof. The adapter comprises a top portion and two side portions extending downwards from the transversely opposite sides of the top portion respectively, a receiving space having a downward opening is formed between the two side portions, each of the side portions is provided with a supporting portion projecting towards the receiving space, and each of the supporting portions is provided with a snap portion moving over from the receiving space towards the two transversely outside sides. A spring sheet of the wiper blade is fixed in the snap portion and the snap portion restricts the displacements of the spring sheet in the upward and downward directions.

### BACKGROUND OF THE INVENTION

The invention relates to the technology regarding a wiper, and in particular, to a wiper blade of a wiper and an adapter thereof.

A vehicle typically uses a wiper to scrape off rain, snow and sundries that are adhered to the windshield, so as to improve visibility through the windshield, increase visual field and enhance safety in traveling. A wiper comprises a wiper blade and a wiping arm. The wiper blade comprises a wiping strip and an adapter fixed to the wiping strip. By means of the adapter, a detachable connection can be realized between the wiper blade and the wiping arm that is in a certain form. The wiping arm drives the wiper blade to perform a scraping movement. When the wiper blade is worn to a certain degree, the wiping arm can be detached from the adapter so that the wiper blade can be conveniently replaced with a new one. However, when the adapter fails to be fixed reliably to the wiping strip, the wiper blade cannot be kept at a predetermined posture to perform scraping, thus having an effect on the performance of the wiper.

Therefore, there is a need for an improved technical solution to overcome existing technical problems in the prior art.

### SUMMARY OF THE INVENTION

The main technical problem to be solved by the invention is to provide a wiper blade, and a connector of which can be fixed to a wiping strip simply and reliably.

In order to address the above technical problems, an aspect of the invention provides an adapter for the wiper blade, which comprises a top portion and two side portions extending downward from the transversely opposite sides of the top portion respectively, a receiving space having a downward opening is formed between the two side portions, each of the side portions is provided with a supporting portion projecting towards the receiving space, and each of the supporting portions is provided with a snap portion moving over from the receiving space towards the two transversely outer sides.

In order to address the above technical problems, another aspect of the invention provides a wiper blade comprising a wiping strip and the adapter as described above, and the wiping strip comprises a longitudinal spring sheet which is fixed in the snap portion and the snap portion restricts the displacement of the spring sheet in the upward and downward directions.

Optionally, the snap portion shaped in a groove that is recessed towards the two transversely outer sides from the receiving space, and a guide surface is provided below the snap portion of the supporting portion, and the guide surface is inclined gradually toward the inner side from a lower portion to an upper portion, and during installation the spring sheet is installed into the snap portion through the guide surface, and when traveling through the guide surface, the spring sheet applies an elastic pressing force to the supporting portion.

Optionally, the wiper blade further comprises a connector provided with a pivot, the connector is fixed to the spring sheet, and the connector is located in the receiving space, and each of the side portions of the adapter is provided with two supporting portions, and the pivot is located between the two supporting portions.

Optionally, the adapter further comprises end walls that respectively extend downwardly from the two longitudinally opposite ends of the top portion, and the two transverse sides of each end wall are connected to the two side portions respectively.

Optionally, the wiping strip further comprises a longitudinal spoiler, a lower edge in the middle portion of each end wall is provided with a notch which mates with the profile of the spoiler, and the spoiler is installed into the notch.

Optionally, two reinforcing walls extending in the longitudinal direction in a spaced relationship are further provided in the receiving space of the adapter, and the reinforcing walls are connected integrally to the end walls, and a lower edge of the reinforcing wall is provided with a moving-over slot, and the pivot is located in the moving-over slot.

Optionally, the adapter is further provided with a through hole for a connection shaft of the wiping arm transversely passing therethrough, and the through hole penetrates through the side portions and the reinforcing walls.

Optionally, the connector comprises a metal base portion, and two side walls which respectively bend upwardly from two transversely opposite sides of the base portion integrally so as to be extended out, the pivot penetrates through the two side walls and is fixed to the two side walls, and the side walls are defined between the reinforcing wall and the supporting portion.

Optionally, a column body is integrally formed between the side portion and the reinforcing wall, the through hole penetrates through the column body, the adapter is formed by injection molding, and the top portion of the adapter is provided with a moving-over opening so that a mold for forming a top surface of the column body passes through the moving-over opening during injection molding.

In the adapter according to the invention, since each supporting portion is provided with the snap portion moving over from the receiving space towards the two transversely outer sides, which can provide a transverse position limiting function for the wiping strip while also provide a position limiting function in the upward and downward direction after the wiping strip is installed upwardly into the receiving space from the opening, the adapter can be simply fixed to the wiper blade stably and reliably in one installation step.

Other aspects and features of the invention will become apparent from the following detailed description made with reference to the accompanying drawings. However, it should be understood that the accompanying drawings are designed for the purpose of illustration only, and are not intended for limiting the scope of the invention since the scope of protection should be defined with reference to the appended claims. It should be also understood that the accompanying drawings merely intend to illustrate the structures and flowcharts described herein in a schematic way and are not necessarily drawn to scale unless otherwise specified.

### BRIEF DESCRIPTION OF THE DRAWINGS

The invention will be more fully understood in connection with detailed description of specific embodiments made with reference to the accompanying drawings, in which identical elements are denoted by identical reference signs throughout the drawings, wherein:

FIG. 1 is a schematic view of the wiper blade having an adapter according to an embodiment of the invention, wherein the adapter is not yet installed onto the wiping strip which is partially omitted in the figure;

FIG. 2 shows a schematic view of the wiper blade shown in FIG. 1 from another perspective, wherein a top surface of the wiper blade is shown with more details;

FIG. 3 shows a schematic view of the wiper blade shown in FIG. 2 after completion of assembly, wherein the adapter is installed onto the wiping strip;

FIG. 4 shows a schematic view of the wiper blade shown in FIG. 3 from another perspective, wherein a bottom surface of the wiper blade is shown with more details;

FIG. 5 shows a schematic view of the adapter of the wiper blade shown in FIG. 3 from a bottom surface; and

FIG. 6 shows a sectional schematic view taken along the line A-A shown in FIG. 3.

### DETAILED DESCRIPTION

The specific embodiments of the invention will be described below in detail with reference to the accompanying drawing so that those skilled in the art can precisely understand the connector claimed in the invention.

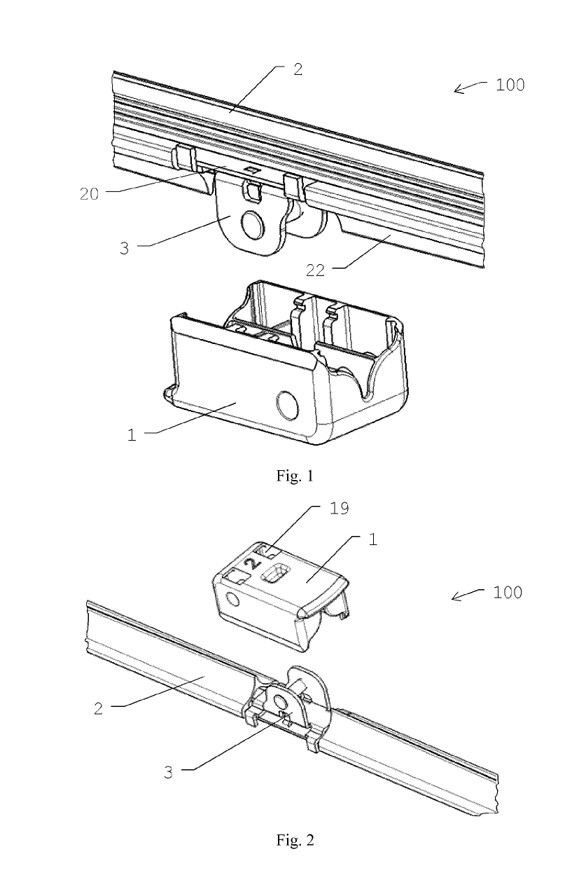

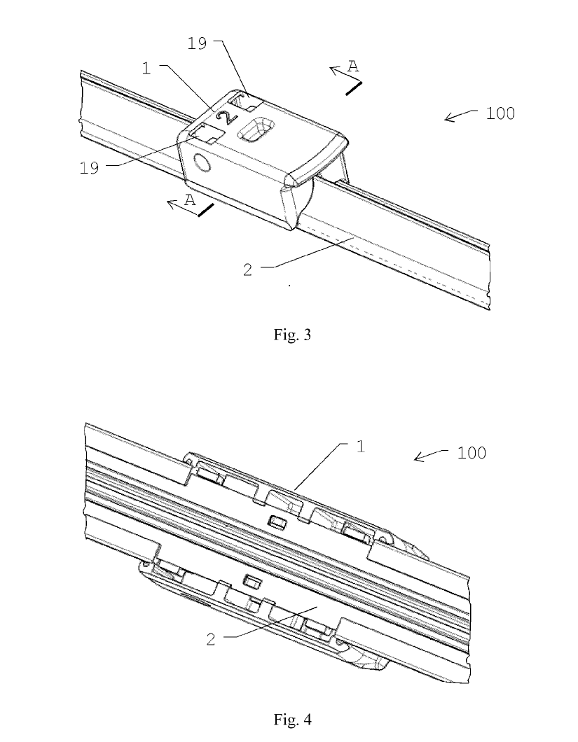

As shown in FIGS. 1 to 6, a wiper blade 100 according to an embodiment of the invention comprises a wiping strip 2 and an adapter 1. In an optional specific embodiment, the wiper blade 100 further comprises a connector 3 as shown in the drawings.

The adapter 1 comprises a top portion 10 and two side portions 12 extending downward from the transversely opposite sides of the top portion 10 respectively, a receiving space 13 having a downward opening is formed between the two side portions 12, each of the side portions 12 is provided with a supporting portion 14 projecting towards the receiving space 13, and each of the supporting portions 14 is provided with a snap portion 140 moving over from the receiving space 13 towards the two transversely outer sides. Optionally, the snap portion 140 shaped in a groove that is recessed towards the two transversely outer sides from the receiving space 13, and a guide surface 142 is provided below the snap portion 140 of the supporting portion 14. The guide surface 142 is inclined gradually toward the inner side from a lower portion to an upper portion, i.e., the lower portion of the guide surface 142 is located outwards than the upper portion of the guide surface 142. The wiping strip 2 comprises a longitudinal spring sheet 20. During installation, the wiping strip 2 is installed into the receiving space 13 from the opening below, and the spring sheet 20 travels through the guide surface 142 from bottom to top so as to be installed into the snap portion 140. Since the guide surface 142 is inclined gradually toward the inner side from a lower portion to an upper portion, the spring sheet 20 applies an elastic pressing force to the supporting portion 14 when traveling through the guide surface 142. When the position of the snap portion 140 in the shape of a groove is reached, the guide surface 142 no longer contacts with the spring sheet 20, thus releasing the elastic force so that the spring sheet 20 automatically enters the snap portion 140 in the shape of groove in a transverse direction. With reference to the sectional schematic view shown in FIG. 6, the spring sheet 20 is fixed to the snap portion 140, and the snap portion 140 restricts a displacement of the spring sheet 20 in the upward and downward directions. Therefore, the installation of the adapter 1 onto the wiper blade 100 can be completed simply in one step, and the adapter 1 can be stably fixed to the wiping strip 2 so that the wiper blade 100 can exhibit an excellent performance.

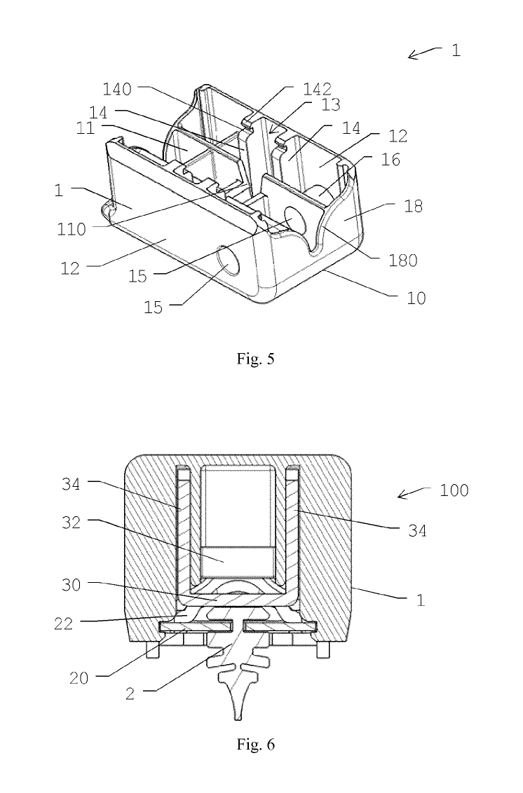

The connector 3 is provided with a pivot 34. The connector 3 is fixed to the spring sheet 20 and is located in the receiving space 13. With reference to the optional specific embodiment as shown in FIG. 5, each of the side portions 12 of the adapter 1 is provided with two supporting portions 14 which have an elongated shape extending in the up and down direction. On one hand, the two supporting portions 14 can provide a good transverse position limiting function for the connector 3; on the other hand, the pivot 34 is located between the two supporting portions 14 so as to provide a longitudinal position limiting function. Optionally, the adapter 1 further comprises end walls 18 that respectively extend downwardly from the two longitudinally opposite ends of the top portion 10, and the two transverse sides of each end wall 18 are connected to the two side portions 12 respectively. That is, the two end walls 18 and the two side portions 12 respectively surround front, rear, left and right sides of the receiving space 13. The wiping strip 2 can further comprise a longitudinal spoiler 22, a lower edge in the middle portion of each end wall 18 can be provided with a notch 180 which mates with the profile of the spoiler 22, and the spoiler 22 is installed into the notch 180. Therefore, not only the spoiler 22 can be limited in position in the notch 18 and protected by the notch 18, but the adapter 1 and the wiping strip 2 form a compact and aesthetically pleasing entirety.

In the optional specific embodiment as shown in the drawings, the receiving space 13 of the adapter 1 is further provided with two reinforcing walls 11 extending in the longitudinal direction in a spaced relationship, and the reinforcing walls 11 are connected integrally to the end walls 18. With such a design in structure, the structural strength of the adapter 1 can be effectively increased. Therefore, there is no need to manufacture the adapter 1 with an expensive material and process. Rather, the adapter 1 can be formed with plastic integrally at a lower cost. A lower edge of the reinforcing wall 11 is provided with a moving-over slot 110, and the pivot 34 of the connector 3 is located in the moving-over slot 110 after completion of installation. Therefore, not only a relative position between the connector 3 and the adapter 1 can be defined, but the connector 3 and the adapter 1 can be coupled together in a compact manner.

Optionally, the adapter is provided with a through hole 15 which penetrates through the side portions 12 and the reinforcing walls 11. During installation of the wiping arm, a connection shaft of the wiping arm can transversely pass through the through hole 15 so as to realize a connection between the wiping arm and the connector 1. In an optional specific embodiment, a column body 16 is integrally formed between the side portion 12 and the reinforcing wall 11, and the through hole 15 penetrates through the column body 16. The top portion 10 of the adapter 1 is provided with a moving-over opening 19 for facilitating injection molding the adapter 1 so that a mold for forming a top surface of the column body 16 passes through the moving-over opening 19 during injection molding.

In an optional specific embodiment, the connector 3 comprises a metal base portion 30, and two side walls 32 respectively bending upwardly from two transversely opposite sides of the base portion 30 integrally so as to be extended out. The pivot 34 penetrates through the two side walls 32 and is fixed to the two side walls 32. The side walls 32 are defined between the reinforcing wall 11 and the supporting portion 14. The base portion 30 and the two side walls 32 can be formed integrally by a metal stamping process, and a circular hole (not indicated in the drawings) for installing the pivot 34 is punched out in each side wall 32. The columniform pivot 34 passes through the two side walls 32 so as to be fixed in an appropriate way such as interference fitting, riveting or welding.

It needs to be illuminated that those skilled in the art will understand, some orientation terms such as “top”, “bottom”, “upper”, “lower”, “longitudinal” and “transverse” are used in the Description for facilitating illustration, and these terms are merely used to indicate relative positional relationships, rather than indicating an absolute spatial position. For example, the orientation terms “top” and “upper” indicate opposite directions to “bottom” and “lower” respectively, whereas the orientation term “longitudinal” indicates a lengthwise direction of the object, and the orientation term “transverse” indicates a perpendicular direction thereto which is generally perpendicular to the up and down direction.

The specific embodiments as described above are merely for the purpose of illustrating the invention, rather than limiting the invention in any way. Those skilled in relevant technical fields can also make various modifications and variations to the invention without departing from the scope of the invention. Therefore, all equivalent technical solutions are within the category of the invention, and the patent protection scope of the invention should be defined by the appended claims.

1. An adapter (1) for a wiper blade (100), the adapter (1) comprising a top portion (10) and two side portions (12) extending downwards from transversely opposite sides of the top portion (10) respectively, wherein a receiving space (13) having a downward opening is formed between the two side portions (12), each of the side portions (12) is provided with a supporting portion (14) projecting towards the receiving space (13), and each of the supporting portions (14) is provided with a snap portion (140) moving over from the receiving space (13) towards the two transversely outside sides.

2. A wiper blade (100) comprising:
a wiping strip (2) including a longitudinal spring sheet (20); and
an adapter (1) including a top portion (10) and two side portions (12) extending downwards from transversely opposite sides of the top portion (10) respectively, wherein a receiving space (13) having a downward opening is formed between the two side portions (12), each of the side portions (12) is provided with a supporting portion (14) projecting towards the receiving space (13), and each of the supporting portions (14) is provided with a snap portion (140) moving over from the receiving space (13) towards the two transversely outside sides;
wherein the spring sheet (20) is fixed in the snap portion (140) and the snap portion (140) restricts displacement of the spring sheet (20) in upward and downward directions.

3. The wiper blade (100) according to claim 2, wherein the snap portion (140) is shaped in a groove that is recessed towards the two transversely outer sides from the receiving space (13), and a guide surface (142) is provided below the snap portion (140) of the supporting portion (14), and the guide surface (142) is inclined gradually toward an inner side from a lower portion to an upper portion, and during installation the spring sheet (20) is installed into the snap portion (140) through the guide surface (142), and when traveling through the guide surface (142), the spring sheet (20) applies an elastic pressing force to the supporting portion (14).

4. The wiper blade (100) according to claim 2, further comprising a connector (3) provided with a pivot (34), wherein the connector (3) is fixed to the spring sheet (20), and the connector (3) is located in the receiving space (13), and each of the side portions (12) of the adapter (1) is provided with two supporting portions (14), and the pivot (34) is located between the two supporting portions (14).

5. The wiper blade (100) according to claim 4, wherein the adapter (1) further includes end walls (18) that respectively extend downwardly from two longitudinally opposite ends of the top portion (10), and two transverse sides of each end wall (18) are connected to the two side portions (12) respectively.

6. The wiper blade (100) according to claim 5, wherein the wiping strip (2) further includes a longitudinal spoiler (22), and a lower edge in a middle portion of each end wall (18) is provided with a notch (180) which mates with a profile of the spoiler (22), and the spoiler (22) is installed into the notch (180).

7. The wiper blade (100) according to claim 5, wherein two reinforcing walls (11) extending in a longitudinal direction in a spaced relationship are further provided in the receiving space (13) of the adapter (1), and the reinforcing walls (11) are connected integrally to the end walls (18), and a lower edge of the reinforcing wall (11) is provided with a moving-over slot (110), and the pivot (34) is located in the moving-over slot (110).

8. The wiper blade (100) according to claim 7, wherein the adapter (1) is further provided with a through hole (15) for a connection shaft of a wiping arm transversely passing therethrough, and the through hole (15) penetrates through the side portions (12) and the reinforcing walls (11).

9. The wiper blade (100) according to claim 4, wherein the connector (3) comprises a metal base portion (30), and two side walls (32) which respectively bend upwardly from two transversely opposite sides of the base portion (30) integrally so as to be extended out, the pivot (34) penetrates through the two side walls (32) and is fixed to the two side walls (32), and the side walls (32) are defined between the reinforcing wall (11) and the supporting portion (14).

10. The wiper blade (100) according to claim 8, wherein a column body (16) is integrally formed between the side portion (12) and the reinforcing wall (11), the through hole (15) penetrates through the column body (16), the adapter (1) is formed by injection molding, and the top portion (10) of the adapter (1) is provided with a moving-over opening (19) so that a mold for forming a top surface of the column body (16) passes through the moving-over opening (19) during injection molding.

11. The wiper blade (100) according to claim 2, wherein the adapter (1) further includes end walls (18) that respectively extend downwardly from two longitudinally opposite ends of the top portion (10), and two transverse sides of each end wall (18) are connected to the two side portions (12) respectively.
